(19) United States
(12) Patent Application Publication
(10) Pub. No.: US 2012/0281720 A1
(43) Pub. Date: Nov. 8, 2012

(54) BROADBAND GENERATION OF COHERENT CONTINUA WITH OPTICAL FIBERS

(75) Inventors: Martin E. Fermann, Dexter, MI (US); Kevin Cossel, Boulder, CO (US); Michael J. Martin, Boulder Creek, CO (US); Ingmar Hartl, Ann Arbor, MI (US); Jun Ye, Louisville, CO (US); Axel Ruehl, Amsterdam (NL)

(73) Assignee: IMRA AMERICA, INC., ANN ARBOR, MI (US)

(21) Appl. No.: 13/458,058

(22) Filed: Apr. 27, 2012

Related U.S. Application Data
(60) Provisional application No. 61/483,472, filed on May 6, 2011.

(51) Int. Cl. H01S 3/067

(52) U.S. Cl. 372/6

(57) ABSTRACT

Coherent and compact supercontinuum light sources for the mid IR spectral regime and exemplary applications are disclosed based on the use highly nonlinear fibers or waveguides. In at least one embodiment the coherence of the supercontinuum sources is increased using nonlinear material with an elevated vibrational contribution to the nonlinear response function. Compact supercontinuum light sources can be constructed with the use of passively mode locked fiber or diode lasers. Wavelength tunable sources can be constructed using appropriate optical filters or frequency conversion sections.

### FIELD OF THE INVENTION

The invention relates to compact high brightness broadband coherent fiber light sources and exemplary applications.

### BACKGROUND

High brightness broadband coherent light sources have many applications in medicine, spectroscopy, microscopy, ranging, sensing and metrology. Such sources need to be highly robust, have long term stability, and also comprise a minimal component count with a high degree of optical integration for mass market applications. Broadband light sources based on frequency broadening or supercontinuum generation in highly nonlinear fibers are particularly useful. When used in conjunction with short pulse fiber lasers, an all-fiber system construction is possible for supercontinuum generation which results in benefits such as greatly simplified manufacturing routines, low cost and high levels of thermo-mechanical stability.

Fiber based supercontinuum sources can produce spectral output from the UV to the mid-IR and have attracted a vast amount of research in the last few years, see for example J. M. Dudley et al., ‘Supercontinuum generation in optical fibers’, Cambridge University Press (2010). To reach the mid-IR, for example the wavelength range from about 2.5-10.0 μm, soft glasses or heavy metal oxide glasses may be implemented for supercontinuum generation, as recently reviewed by J. H. V. Price et al., ‘Supercontinuum generation and nonlinearity in soft glass fibers’, in chapter VI of J. M. Dudley et al., ‘Supercontinuum generation in optical fibers’, Cambridge University Press (2010). Such fiber based mid-IR sources operating in the mid-IR can potentially replace more established optical parametric oscillators (OPOs), amplifiers (OPAs) and generators (OPGs) and are therefore of considerable interest.

However, to date, mid-IR supercontinuum sources are still relatively difficult to manufacture. Also the understanding of supercontinuum generation in soft-glass fibers is limited. Moreover, no highly coherent supercontinuum generation in soft or heavy metal oxide glasses has yet been demonstrated.

Detailed theoretical investigations of supercontinuum generation and the coherence of supercontinuum generation in telluride photonic crystal fibers were presented by W. Q. Zhang et al., ‘A genetic algorithm based approach to fiber design for high coherence and large bandwidth supercontinuum generation’, Opt. Expr., vol. 17, pp. 19311 (2009). However no differentiation between amplitude and phase noise was apparent from this work. Moreover, extremely difficult to manufacture fibers with ultra-flat dispersion profiles were suggested for the generation of wide band coherent supercontinuum spectra. A fiber laser source for supercontinuum generation was not considered. In related work presented in Buccoliero et al., Appl. Phys. Lett., vol. 92, pp. 061106 (2010) results assuming a Tm fiber laser generating 5 ps pulses for supercontinuum generation in a tellurite photonic crystal fiber were discussed, but only pulses with a pulse width of 5 ps were considered.

In contrast, highly nonlinear fibers based on silica glass have already reached a relatively high level of maturity. To reduce the pulse energy requirements for supercontinuum generation, highly nonlinear silica fibers with extremely small cores are beneficial. For example, silica based highly nonlinear fibers were recently described in Dong et al., ‘Ultra high numerical aperture optical fibers’, U.S. Pat. No. 7,715,672. Silica fiber based supercontinuum sources employing short pulse fiber sources were for example described in T. Hori, ‘Studies on Ultrawideband Supercontinuum Generation by Use of Ultrashort Pulse and Optical Fibers’, Ph.D. Thesis, Nagoya University, Japan (2005). These all-fiber supercontinuum sources were operated using short pulse lasers emitting at wavelengths near 1560 nm and used highly nonlinear silica fibers with high levels of Germania concentration inside the core. Such all fiber sources were also shown to produce supercontinua with high levels of coherence and were used in the demonstration of ultra-low noise frequency comb sources in W. C. Swann et al., Fiber-laser frequency combs with subhertz relative bandwidths, Opt. Lett., vol. 31, pp. 3046-3048 (2006). Low noise frequency comb sources operating with laser sources emitting near 1550 nm can operate at repetition rates in the range from 50-1000 MHz. The upper limit is generally governed by design constraints of the laser sources implemented. The lower limit is governed by mechanical stability considerations.

Thus, there still remains a need for low noise supercontinuum sources that can operate at repetition rates >1 GHz, particularly at wavelengths near 1550 nm. There also still remains a need for low noise supercontinuum sources that can operate with short pulse laser sources operating at wavelengths >1600 nm or <1400 nm. Also there still remains a need for low noise all-fiber supercontinuum sources with broad spectral coverage. Finally, there still remains a need for low noise highly coherent supercontinuum sources based on soft glasses or highly nonlinear waveguides.

### SUMMARY OF THE INVENTION

Low noise fiber based coherent supercontinuum sources allowing for broad spectral coverage are described. In order to increase the coherence of the supercontinuum, highly nonlinear fibers having a nonlinear response with an enhanced vibrational contribution are implemented. In particular, the relative vibrational contribution α to the nonlinear response function is selected to be α>0.18 in silica glasses. Alternatively, the ratio R=(peak Raman gain coefficient)/(nonlinear refractive index) is selected such that R>5×10⁶ m⁻¹. An elevated level of a improves the coherence properties, the amplitude noise as well as the phase noise in a generated supercontinuum. The inventors discovered that a remarkably high level of coherence was achievable in a fiber-based laser system, even without dispersion flattening of the supercontinuum fiber (SCF).

Highly coherent, low noise supercontinuum generation is possible using fiber laser sources as well as any laser source producing short pulses. These short pulse laser sources preferably generate pulse widths <1 ps, more preferably pulse widths <300 fs, and most preferably pulse widths <100 fs. Highly nonlinear silica fibers with an elevated nonlinear vibrational contribution to the nonlinear response can be produced by using high levels of Germania doping inside the fiber core. Germania doping levels >10 mole % and more preferably >20 mole % can be implemented. Highly Germania doped highly nonlinear fibers using step index refractive index profiles, W shaped index profiles or more complex refractive index profiles can be readily implemented. For wavelengths >1700 nm, highly nonlinear fibers with an elevated nonlinear vibrational contribution to the nonlinear response can be further designed to be dispersion flattened while providing an all-glass design based on germanosilicate glass.

Germania doped photonic crystal fibers incorporating air-holes surrounding a central core section can also be readily used to increase the vibrational contribution to the nonlinear response. Such Germania doped photonic crystal fibers are particularly useful when using laser sources with emission wavelengths >1700 nm or <1400 nm, where the amount of dispersion management with conventional step index fibers is somewhat limited.

Alternatively, particularly for coherent supercontinuum generation at wavelengths >2000 nm, many varieties of soft glass- or heavy metal oxide-based highly nonlinear fibers with a large Raman cross section can be utilized which can be selected to also have an elevated vibrational contribution to the nonlinear response. Such soft or heavy metal oxide glass highly nonlinear fibers can, for example, comprise fluoride, lead-glass, bismuth, chalcogenide or tellurite based fibers. These soft glasses are preferably selected with α>0.10 or R>2×10⁶ m⁻¹. The corresponding fibers made from these glasses have preferably a dispersion flattened profile. For example, preferably the fiber will have a value of dispersion <|50|ps²/km in a range extended to ±100 nm from the center wavelength of the utilized laser source; more preferably, the range will be ±200 nm and most preferably the range will be ±500 nm.

As an alternative to supercontinuum generation in soft glasses, highly nonlinear waveguides, such as for example silicon, silicon nitride (Si₃N₄), bismuth, chalcogenide, GaAs, LiNbO₃ or GaP based waveguides can be utilized. These highly nonlinear waveguides are preferably selected with α>0.11.

As an example, a coherent supercontinuum source may comprise a fiber-based pulse source generating an output at a central wavelength >1700 nm, the output including at least one pulse having a pulse width <1 ps. A highly nonlinear material receives the output from the source and generates a coherent supercontinuum. A high level of coherence may be characterized by having a first order coherence function >0.9 obtainable at two spectral locations within the supercontinuum, wherein the spectral locations are separated by at least half an octave or one octave. In some embodiments the fiber based pulse source may operate at a repetition rate of at least about 1 GHz. In some embodiments the spectral locations may be separated by about 1.1 octaves.

### BRIEF DESCRIPTION OF THE DRAWINGS

FIG. 1 schematically illustrates a generic embodiment of a low noise broadband supercontinuum source implementing a highly nonlinear fiber with an elevated vibrational contribution to the nonlinear response function.

FIG. 2a is a SEM image illustrating a cross section of a highly nonlinear germania doped silica photonic crystal fiber with an elevated vibrational contribution to the nonlinear response function.

FIG. 3 schematically illustrates an exemplary fiber-based, low noise broadband supercontinuum source which includes a highly nonlinear silica fiber with an elevated vibrational contribution to the nonlinear response function.

FIG. 4a is a plot of an exemplary low noise broadband supercontinuum spectrum generated with a system according to FIG. 3, which includes a short pulse source and a highly nonlinear silica fiber with an elevated vibrational contribution to the nonlinear response function.

FIG. 4b is a plot illustrating the coherence within an exemplary low noise broadband supercontinuum spectrum generated with the short pulse source implementing a highly nonlinear silica fiber with an elevated vibrational contribution to the nonlinear response function.

FIG. 4c is a series of plots illustrating the following simulation results: (top, dashes) a simulated low noise broadband supercontinuum spectrum based on a model of a short pulse source and a highly nonlinear silica fiber with an elevated vibrational contribution to the nonlinear response function; (top, solid) the corresponding coherence; (bottom, solid) the corresponding phase noise; and (bottom, dots) the corresponding amplitude noise.

### DETAILED DESCRIPTION

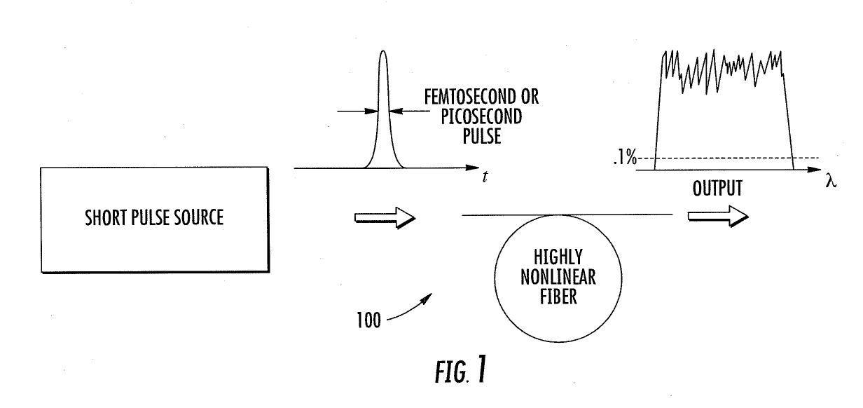

FIG. 1 illustrates a design of a low noise, broadband, supercontinuum source 100 implementing a highly nonlinear fiber with an elevated vibrational contribution to the nonlinear response function In various embodiments a highly nonlinear fiber is configured in such a way that the vibrational contribution to the nonlinear refractive index N₂ increases relative to the electronic contribution, as will be discussed below. In operation the pulse characteristics of the short pulse source, combined with the elevated vibrational contribution of the nonlinear fiber, produce a highly coherent supercontinuum.

The short pulse source can be any laser source producing pulses with pulse widths <5 ps, more preferably <1 ps, even more preferably pulse widths <300 fs, and most preferably pulse widths <100 fs. Appropriate sources can, for example, comprise mode locked fiber lasers, mode locked semiconductor or solid state lasers. In at least one embodiment a single mode output beam from a short pulse source is coupled into the highly nonlinear fiber and mode matched to the non-linear fiber using mode matching bulk and/or integrated optics, direct splicing, and/or fiber tapers. The highly nonlinear fiber can be tapered to simplify and stabilize coupling to the source. The highly nonlinear fiber can also be spliced to short sections of optical fiber with increasing mode diameter in the upstream direction of the highly nonlinear fiber to simplify coupling. Also the highly nonlinear fiber can be tapered or more than one highly nonlinear fiber can be used to further shape the continuum output, i.e. several highly nonlinear fibers can be concatenated. A taper can also be used to modify and control the dispersion characteristics of the fiber in order to increase the spectral width, maximize the coherence of the supercontinuum, and to reduce the power requirements for supercontinuum generation. The taper can be implemented with silica or non-silica fibers.

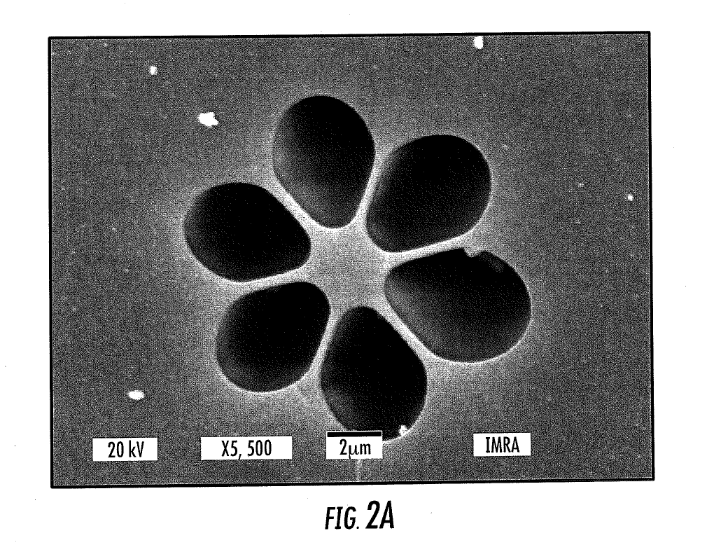

An appropriate highly nonlinear fiber can comprise any fiber capable of providing an elevated vibrational contribution to the nonlinear response function. By way of example, an SEM image illustrating an exemplary cross section of such a fiber is shown in FIG. 2a. The fiber is based on a silica glass with a central core with a diameter of 3 μm surrounded by six air holes, and is an example of a photonic crystal fiber (PCF) configuration. The dispersion of the fiber at a wavelength of 1060 nm was calculated as ≈−20 ps²/km. During the manufacturing process a germanosilicate glass rod with a Germania concentration of around 19 mole % is inserted into the central core region using a stack and draw technique. Such fibers were disclosed in Dong et al., ‘Ultra high numerical aperture optical fibers’, U.S. Pat. No. 7,715,672, the contents of which are hereby incorporated by reference. The Germania doped central core region contains about 32% of the core area; the Germania doped central core region has a diameter of around 1.7 μm, i.e. a diameter of around 57% of the overall core diameter. Because of the strong confinement of the fiber mode within the core boundaries, the Germania doped central core region has a very high overlap with the fiber mode. The nonlinearity of the photonic crystal fiber is dominantly governed by the nonlinearity of the Germania doped central core region.

As shown in F. A. Oguama et al., ‘Simultaneous measurement of the Raman gain coefficient and the nonlinear refractive index of optical fibers: theory and experiment’, J. Opt. Soc. Am. B, vol. 22, 426 (2005), the nonlinear refractive index N₂ of optical fibers increases with the Germania content, therefore, the incorporation of Germania into the core of a PCF increases the nonlinear refractive index of such fibers. Moreover, Oguama et al., also show that the Raman gain coefficient in such fibers increases more rapidly than the nonlinear refractive index with an increase in Germania concentration. Specifically, from table 1 of Oguama et al., the ratio R=(peak Raman gain coefficient)/(nonlinear refractive index N₂) is evaluated as ≈4×10⁶ m⁻¹ for a pure silica core fiber and R≈14×10⁶ m⁻¹ for a germanosilicate fiber with 30 mole % GeO₂ codoping. Thus in the germanoscilicate fiber R is about 3.5 times higher than in the pure silica core fiber.

Hence, the fiber as shown in FIG. 2a also has an increased Raman gain compared to a similar PCF without a central germanosilicate section. As is well known in the state of the art, the relative contributions of electronic and vibrational components to the nonlinear refractive index, N₂, can be written as

N₂=N₂₀(1−α)+αN₂₀, (1)

where N₂₀(1−α) is the electronic contribution and αN₂₀ is the vibrational contribution with α=0.18 in silica fibers. As is well known in the state of the art, the value of α can be obtained from a measurement of the nonlinear refractive index N₂ as well as the Raman gain as a function of wavelength as for example described in W. Q. Zhang et al., ‘A genetic algorithm based approach to fiber design for high coherence and large bandwidth supercontinuum generation’, Opt. Expr., vol. 17, pp. 19311 (2009). Specifically, as shown by Zhang et al., α can be calculated as:

$$α = \frac{{\int }_{0}^{∞} {F}^{- 1} [ {N}_{2} ( Ω ) ] d t}{{N}_{2}} , \qquad ( 2 )$$

where F⁻¹[N₂(Ω)] denotes the inverse Fourier transform of the real part of the nonlinear refractive index N₂(Ω) as a function of frequency Ω and N₂ is the nonlinear refractive index at the operating wavelength. N₂(Ω) is obtained via a Kramers Kronig relation from the Raman gain coefficient as a function of frequency, as well known in the state of the art.

For chemically similar glasses (for example the group of silicate glasses with a glass softening point >1200 deg. C.), and to first order approximation, α is proportional to the ratio R. Therefore, to first order, the vibrational contributions to the nonlinear refractive index, as described by α, also increase with Germania concentration in silicate glasses. In the fiber shown in FIG. 2a, α was estimated as β≈0.30. Thus α is around 1.67 times higher compared to a pure silica fiber.

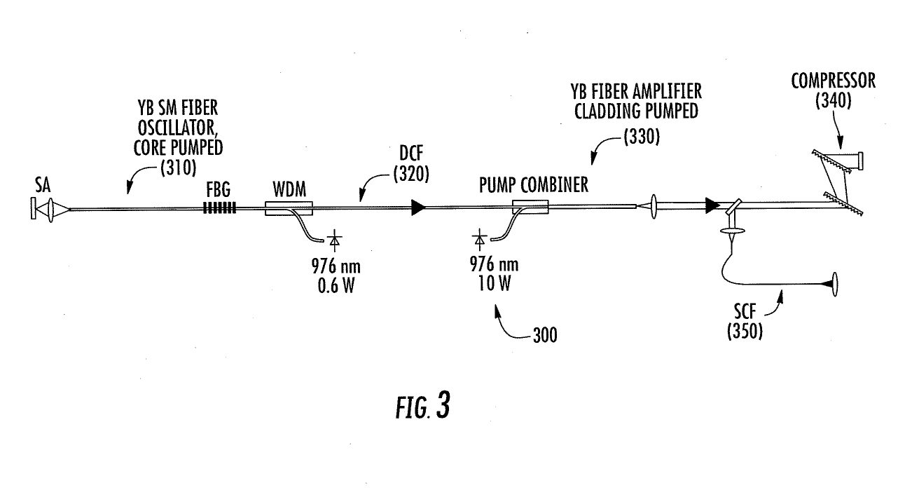

The inventors have discovered that the coherence of supercontinuum spectra generated in fibers with an increase in a also increases. For the purpose of our analysis, and more generally, the first order coherence g(ω) as a function of optical frequency ω in the supercontinuum spectrum is defined as

$$g ( ω ) = \frac{\vert {〈 {A}_{i} ( ω ) {A}_{j}^{*} ( ω ) 〉}_{i \neq j} \vert}{\sqrt{〈 {\vert {A}_{i} ( ω ) \vert}^{2} 〉 〈 {\vert {A}_{j} ( ω ) \vert}^{2} 〉}} , \qquad ( 3 )$$

where A_{i,j}(ω) is the amplitude of the supercontinuum spectrum generated by the i′th and j′th pulse, where the integers are randomly selected within the pulse train. The characterization of supercontinuum spectra with a coherence function g(ω) or g(λ) (where λ is the corresponding wavelength at optical frequency ω) is well known in the state of the art and further also used in W. Q. Zhang et al., ‘A genetic algorithm based approach to fiber design for high coherence and large bandwidth supercontinuum generation’, Opt. Expr., vol. 17, pp. 19311 (2009) and not further described here. However, Zhang et al. did not consider the phase and amplitude noise corresponding to the coherence function from FIG. 3. Phase noise, for example, can be critical in coherent or interferometric measurement techniques. In principle, a pulse source can have large amplitude noise, but still have very small values of phase noise. Alternatively, a pulse source can be shot noise limited, but still have very large phase noise. The phase and amplitude noise can be simulated by calculating the variance of the argument and amplitude of A(ω) by taking an average over many pulse spectra. To spectrally resolve the phase and amplitude noise contributions, these variances can be calculated in individual narrow spectral bins across the whole supercontinuum spectrum.

Experimentally, the first order coherence can be approximately measured using a Mach-Zehnder interferometer, where two subsequent pulses from the pulse source are interfered and the visibility of the generated spectral interferogram is observed as a function of optical frequency, where

$$g ( ω ) \approx \frac{{I}_{max} ( ω ) - {I}_{min} ( ω )}{4 \sqrt{{I}_{1} ( ω ) {I}_{2} ( ω )}} . \qquad ( 4 )$$

Here I_{max, min}(ω) are the max and min spectral intensity in the observed spectral interferogram respectively and I_{1,2}(ω) are the spectral intensities obtained in the two arms of the Mach-Zehnder interferometer respectively. This measurement technique is well known in the state of the art and does not need any further explanation; for example it was described with respect to FIG. 10a in U.S. Pat. No. 6,775,447 to Nicholson et al.

The increase in coherence g with an increase in α can be significant and allow the generation of highly coherent supercontinuum spectra with an optical bandwidth exceeding 1 octave. For our purpose, and unless otherwise specified, the optical supercontinuum bandwidth is to be understood as the spectral bandwidth measured between the two most extreme spectral points where the generated spectral density is at least about 0.1% of the peak spectral density in the continuum. Alternatively, we refer to these extreme spectral points as the −30 dB points.

An exemplary set-up of such an ultra-broadband, highly coherent supercontinuum source 300 is shown in FIG. 3. The configuration was used to produce exemplary results discussed below. A passively mode locked Yb fiber oscillator 310 generating parabolic pulses with a pulse width compressible to around 60 fs, a pulse energy of 1 nJ at a repetition rate of 152 MHz, and a center wavelength of 1060 nm is shown. The Yb oscillator 310 is configured with a Fabry-Perot cavity and is bounded by the saturable absorber mirror SA and the fiber Bragg grating FBG on its two sides. Such oscillators were disclosed with respect to FIG. 14 in US Patent Application Pub. No. 2010/0260214, entitled “Single-polarization high power fiber lasers and amplifiers”, to Fermann et al., and also U.S. Pat. No. 7,649,915, entitled “Pulsed laser sources” to Fermann et al. and are not further described here.

In this example the output of the Yb oscillator was temporally stretched in a length of dispersion compensating fiber (DCF) 320 and was further amplified in an 80 cm length of 12 μm core diameter double-clad Yb fiber power amplifier 330 to an output power of up to 1 W. The amplified pulses were subsequently recompressed in a dual grating compressor 340 based on two bulk diffraction gratings with a groove density of 1200 l/mm operated in transmission in a Littrow configuration. The DCF 320 was further chosen to minimize self-phase modulation in the Yb power amplifier 330 and to compensate for residual third order dispersion in the system, allowing for the generation of pulses with a pulse width of 80 fs after compression by the bulk grating compressor 340. Temporally compressed pulses with pulse energy up to 1.2 nJ were then coupled into a 20 cm length of a highly nonlinear supercontinuum fiber (SCF) 350 for the generation of the supercontinuum spectra, where the same fiber as described with respect to FIG. 2a was used. Here the source shown in FIG. 3 serves only as an example; any other short pulse laser source providing suitable pulse characteristics may also be implemented.

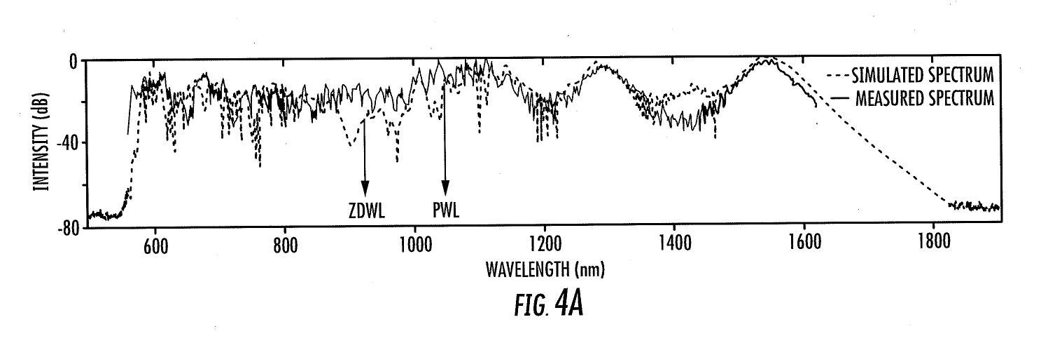

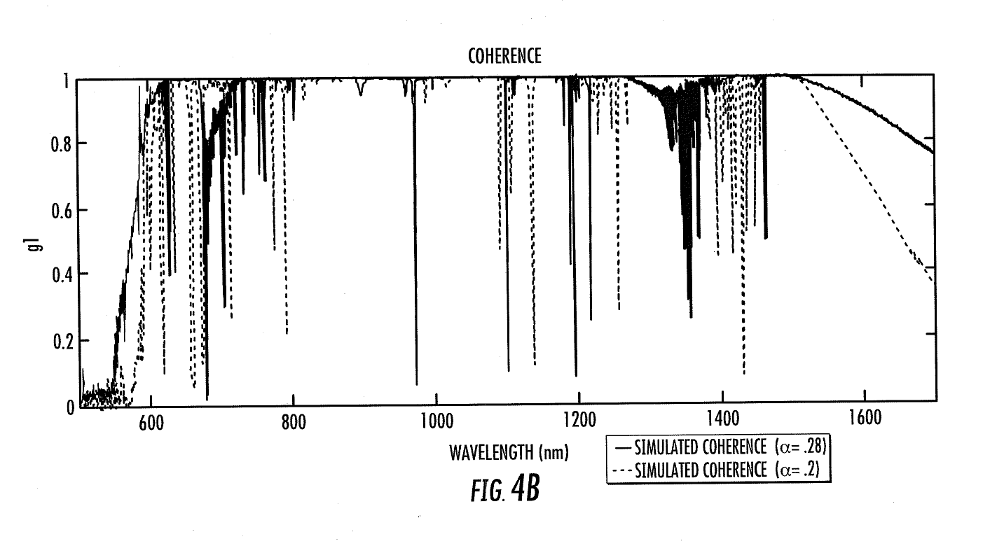

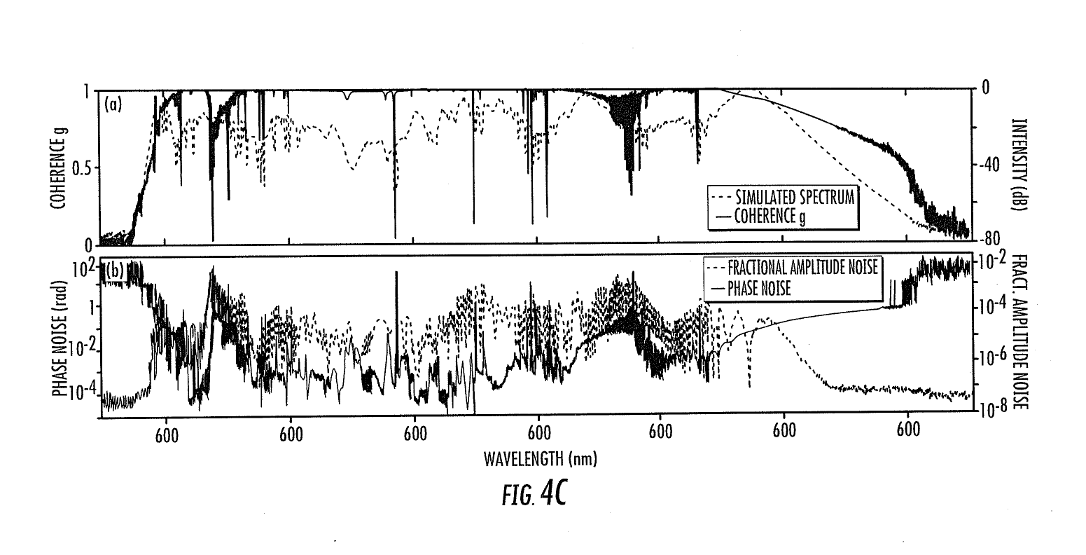

The supercontinuum spectrum generated with the system of FIG. 3 is shown in FIG. 4a (solid line) along with a numerically simulated supercontinuum spectrum (dashed line). The numerical simulation was performed using a procedure well known in the state of the art and for example described in W. Q. Zhang et al., ‘A genetic algorithm based approach to fiber design for high coherence and large bandwidth supercontinuum generation’, Opt. Expr., vol. 17, pp. 19311 (2009). Excellent agreement between experimental and theoretical data was obtained. The calculated coherence from eq. (3) as a function of optical wavelength g(λ) is further shown in FIG. 4b, (solid line), which shows near perfect coherence (i.e. g>0.9) in a wavelength span from 630-1600 nm. Here the simulation was performed assuming a vibrational contribution to the nonlinear response function of the SCF of α=0.28. In comparison the simulated coherence as a function of wavelength g(λ) is also shown in FIG. 4b assuming α=0.20 (dashed line). The results show an increase in a improves the coherence properties of the supercontinuum. The improved coherence is mainly visible at the spectral fringes of the generated supercontinuum and in regions with reduced spectral density. In particular a coherence >0.9 is obtained in a spectral span exceeding an octave. Alternatively, the coherence could also be approximately measured using a Mach-Zehnder interferometer as explained with respect to eq. (4).

The high level of coherence and the low level of phase noise obtained with the SCF as shown in FIG. 2a, and utilized as the SCF shown in FIG. 3 was further experimentally verified by beating individual spectral components with a variety of single frequency lasers operating at various wavelengths and measuring the beat signal with a radio-frequency (RF) analyzer. Dual balanced detection of the beat signal between the single-frequency laser and the generated continuum could further be implemented for minimization of amplitude noise contributions. In frequency metrology a low level of phase noise means that the S/N ratio of the measured beat signal with a single-frequency laser within the supercontinuum spectrum is high enough to enable phase locking between the single-frequency lasers and individual frequency comb lines within the supercontinuum spectrum. In practice using standard electronics, phase locking is possible when a S/N ratio>20 dB is obtained at 100 kHz spectral resolution on an RF analyzer when measuring the beat signal between the single frequency lasers and an individual comb line within the supercontinuum spectrum. In the following we therefore adopt the definition that high phase coherence at a spectral point within the supercontinuum means a S/N ratio>20 dB is obtainable at 100 kHz spectral resolution on an RF analyzer when measuring the beat signal between a single frequency laser and an individual comb line within the supercontinuum spectrum.

FIG. 4c illustrates the simulated supercontinuum spectrum obtained with the fiber shown in FIG. 2a used with the laser system shown in FIG. 3. The simulated coherence, and simulated amplitude and phase noise contributions are also shown in FIG. 4c. Indeed it can be seen that low levels of phase noise can be obtained in the presence of significant amplitude noise.

The high level of coherence in the SCF fiber as shown in FIG. 2a was strongly dependent on pulse width; best results were obtained with injection of very short pulses. In this example, increased coherence properties were obtained with a pulse width <100 fs, less optimum coherence properties were obtained with pulse widths <300 fs; even less optimum coherence properties were obtained with pulse widths <1 ps; even more degraded coherence properties were obtained with pulse widths >1 ps. Generally, the utilization of short optical pulses is a requirement for the generation of coherent supercontinua in silica highly nonlinear fibers, as is well known in the state of the art. However, highly nonlinear fibers with large values of α can relax the short pulse width requirements while still preserving high levels of supercontinuum coherence. Thus, picosecond pulses may be utilized in some embodiments in which a highly coherent supercontinuum is to be generated.

A high level of coherence can be important for improving the S/N ratio of any subsequent spectral measurements based on the supercontinuum. Shot noise limited optical sources are highly desirable in such measurement techniques. A coherence value close to unity ensures that no additional noise gets added to the short pulse laser source noise via the process of supercontinuum generation. Hence, provided a shot noise limited source generates the supercontinuum, the generated continuum will also be shot noise limited. On the other hand, if supercontinuum generation produces an excess amplitude noise level of 10 dB above shot noise, a hundred times longer signal averaging time may need to be implemented to achieve the same S/N ratio in signal detection compared to when a shot noise limited source is used. However, shot noise limited performance does not ensure low phase noise, and thus cannot ensure particularly high phase coherence.

Some short pulse sources may produce excess noise levels. In this case coherence in the vicinity of unity ensures that the level of excess noise does not increase in the process of supercontinuum generation which is also highly desirable.

The high level of coherence obtained with the fiber shown in FIG. 2a is remarkable since the SCF had a relatively high value of dispersion of about −20 ps²/km and was not dispersion flattened. Even better coherence properties can be expected with dispersion flattened designs. The zero dispersion wavelength of the fiber shown in FIG. 2a and the implemented pump wavelength for supercontinuum generation are further denoted by (ZDW) and (PWL) respectively.

The spectral extent of coherent supercontinuum generation may further be increased by concatenation of a additional highly nonlinear fibers as well as appropriate tapering of the implemented highly nonlinear fibers.

In particular, when using a Ti:sapphire laser operating in a spectral range from 700-900 nm, the use of a highly nonlinear PCF with a central Germania doped fiber section can improve the coherence properties of the generated supercontinuum. Alternatively, when using a short pulse source operating in the 1050 or 1550 nm wavelength regions, the use of a highly nonlinear PCF reduces the pulse energy requirements for supercontinuum generation and maximizes the coherence properties of the generated supercontinuum, thus allowing for the generation of coherent supercontinua using short pulse fiber or diode laser based sources operating at repetition rates >1 GHz.

When using short pulse light sources operating at wavelengths >1700 nm, the use of highly nonlinear silica fibers with a large Germania content also greatly increases the coherence properties of the generated supercontinuum. In various preferred embodiments a Germania concentration >10 mole % is desired, a Germania concentration >20 mole % is more desirable, and a Germania concentration >30 mole % is most desirable. The coherence properties of the generated supercontinuum can further be increased by using dispersion flattened fiber designs, as enabled by using a photonic crystal structure to define a core region, a W-refractive index profile or more complex refractive index profiles. The highly nonlinear fibers preferably have a value of dispersion <|50|ps²/km in a range extended to ±100 nm from the center wavelength of the laser source; more preferably, the range can be ±200 nm and most preferably the range can be ±500 nm.

In order to increase the spectral coverage of supercontinuum generation to wavelengths >2500 nm, it is desirable to use soft glass- or heavy metal oxide glass-based fibers or to use highly nonlinear waveguides. Such mid IR transmitting glasses can for example be based on tellurite, chalcogenide, SF6, lead or fluoride. However, other glasses can also be used in various embodiments. Nonlinear waveguides can be based on silicon, silicon nitride, bismuth or tellurite to name a few examples. The coherence of these mid-IR supercontinuum sources can further be maximized by selecting nonlinear materials with a nonlinear response with an enhanced vibrational contribution. As is well known in the state of the art, soft glasses can be fabricated with widely different physical, chemical or optical properties depending on the details of the glass composition. The supercontinuum bandwidth achievable from such highly nonlinear fibers or waveguides can exceed one to two octaves and can exceed four octaves in some cases, for example a wavelength spread from 400-9000 nm can be achieved. By way of example, a supercontinuum bandwidth may be in the range from at least about one-half octave and up to about four octaves.

For example the properties of tellurite and fluorotellurite glass based fibers were recently reviewed in M. D. O'Donnell et al., ‘Tellurite and Fluorotellurite Glasses for Fiberoptic Raman Amplifiers: Glass Characterization, Optical Properties, Raman Gain, Preliminary Fiberization, and Fiber Characterization’, J. Am. Ceram. Soc., vol. 90, pp. 1448 (2007). From table III of M. D. O'Donell et al., it can be seen that the peak Raman gain in such glasses can vary by almost a factor of ten depending on the details of the glass composition.

In contrast, the variation of N₂ in tellurite glasses is only of the order of 2-3, as shown in FIG. 6.2 of H. V. Price et al., ‘Supercontinuum generation and nonlinearity in soft glass fibers’, in chapter VI of J. M. Dudley et al., ‘Supercontinuum generation in optical fibers’, Cambridge University Press (2010). Hence we can expect that R=(peak Raman gain coefficient)/(nonlinear refractive index) also varies largely in tellurite fibers; based on the data by Price et al. and M. D. O'Donell et al., the variation of R is expected to be in the range from ≈4×10⁵ m⁻¹ to 8×10⁶ m⁻¹. Specifically, M. D. O'Donell et al., describe the peak Raman gain of FT3 glass as around 8.5×10⁻¹³ m/W, whereas the nonlinear refractive index of FT3 glass is described as N₂=5.9×10⁻¹⁹ m²/W in W. Q. Zhang et al., wherein α is further evaluated as α=0.064 (using a calculation procedure as explained with respect to eq. (2)). Hence R=1.7×10⁶ m⁻¹ for FT3 glass. Based on the large variation of R a large variation of α can be expected. Especially, α>0.064 can be expected for fiber with a relatively high peak Raman gain. In a recent publication a was estimated as α=0.51 in tellurite TBZN glass fiber in X. Yan et al., ‘Transient Raman response and soliton self-frequency shift in tellurite microstructured fiber’, Journal of Applied Physics, vol. 108, pp. 123110 (2010).

Thus, favorable high coherence and low noise supercontinuum spectra can be obtained in tellurite glasses with α>0.064 or alternatively with R>1.7×10⁶ m⁻¹. In an exemplary chalcogenide glass α was evaluated as α=0.10 in Hu et al., ‘Maximizing the bandwidth of supercontinuum generation in As₂Se₃ chalcogenide fibers’, Opt. Expr., vol. 18, pp. 6722 (2010). Thus the fiber described by Hu et al. was not optimized for the generation of highly coherent supercontinua and improved supercontinuum coherence properties can be expected by selecting chalcogenide based highly nonlinear fibers with a value of α>0.10. Chalcogenide fibers can be conveniently fabricated with a chalcogenide core and a silica cladding as, for example, discussed in N. Granzow et al., Supercontinuum generation in chalcogenide-silica step-index fibers, Opt. Express, vol. 19, 21003 (2011)

Generally, the coherence of supercontinuum spectra in the mid IR can be increased in any soft glass or heavy metal oxide glass based highly nonlinear fiber by selecting materials with α>0.10 or R>1.7×10⁶ m⁻¹. It is sufficient to provide such materials only in the core of such highly nonlinear fibers. The cladding region can comprise a different material, such as for example silica glass as discussed by Granzow et al.; however, other cladding materials can also be implemented. The highly nonlinear fibers are preferably designed with a dispersion flattened dispersion profile, however, only a moderate amount of dispersion flattening can be implemented For example, the fibers can have a value of dispersion D₂:|5|<D₂|50|ps²/km in a range extended to ±100 nm from the center wavelength of the utilized laser source. More preferably, the range can be ±200 nm. Most preferably, the range can be ±500 nm. In contrast, Zhang et al. suggested to use fibers with extreme levels of dispersion flattening, where the dispersion was selected to be D₂:D₂<|5|ps²/km in a wavelength span exceeding 1000 nm.

The utilization of short pulse sources with an emission wavelength >1700 nm further minimizes detrimental effects from photo darkening and multi-photon absorption in such materials. These short pulse laser sources preferably generate pulse widths <1 ps, more preferably pulse widths <300 fs, and most preferably pulse widths <100 fs. Such short pulse sources can be conveniently based on mode locked Tm fiber lasers and amplifiers as for example disclosed in Fermann ‘Compact, coherent, high brightness light sources for the mid and far IR’, U.S. patent application Ser. No. 13/026,762. However, any other suitable short pulse source operating at a wavelengths >1700 nm can be used.

As an alternative to highly nonlinear fibers, highly nonlinear waveguides may also be used for supercontinuum generation. For example, supercontinuum generation was demonstrated in M. R. E. Lamont et al., ‘Supercontinuum generation in dispersion engineered highly nonlinear (γ=10/W/m) As₂S₃ chalcogenide planar waveguide’, Opt. Expr., vol. 19, pp. 14938 (2008). However, the coherence properties of the generated supercontinuum were not investigated and the value of α was estimated as α=0.11. Thus, the waveguide described by Lamont et al. was not optimized for the generation of highly coherent supercontinua. As discussed above, improved supercontinuum coherence properties can be expected by selecting chalcogenide based highly nonlinear waveguides with a value of α>0.11.

Instead, of chalcogenide highly nonlinear waveguides, other waveguide material can be implemented; such nonlinear waveguides can be based on bismuth or tellurite glass, silicon or silicon nitride to name a few examples. Also for these waveguides the use of materials with α>0.11 is beneficial to increase the coherence of the supercontinuum output.

Generally, the coherence of supercontinuum spectra in the mid IR can be substantially increased in any highly nonlinear waveguide by selecting materials with α>0.11. The highly nonlinear waveguides are preferably designed with a dispersion flattened dispersion profile. The waveguides preferably have a value of dispersion <|50|ps²/km in a range extended to ±100 nm from the center wavelength of the utilized laser source. More preferably, the range can be ±200 nm and most preferably the range can be ±500 nm.

Thus, the invention has been described in several embodiments. It is to be understood that the embodiments are not mutually exclusive, and elements described in connection with one embodiment may be combined with, or eliminated from, other embodiments in suitable ways to accomplish desired design objectives.

At least one embodiment includes a supercontinuum source. The supercontinuum source includes a fiber-based laser source generating short optical pulses. The source generates output pulses at a central wavelength >1700 nm. The short optical pulses include one or more pulses having a pulse width <5 ps. A highly non-linear waveguide, which includes a highly nonlinear material, is arranged to receive output pulses from the fiber-based source and to generate a supercontinuum. The generated supercontinuum is characterized by having a first order coherence function >0.9 obtainable at two spectral locations within the supercontinuum, wherein the spectral locations are separated by at least one-half octave.

In any or all embodiments a highly non-linear waveguide may include a highly nonlinear silica fiber having a core region with a Germania concentration >10 mole %.

In any or all embodiments a highly nonlinear silica fiber may be dispersion flattened with a dispersion value <|50|ps²/km in a spectral range within ±100 nm of the central wavelength of the laser source.

In any or all embodiments the continuum may cover a spectral bandwidth larger than one-half octave measured between two −30 dB points.

In any or all embodiments a highly non-linear waveguide may include dispersion flattened optical fiber.

In any or all embodiments a highly non-linear waveguide may include photonic crystal fiber.

In any or all embodiments photonic crystal fiber may be silica based and may include a core region with a Germania concentration >10 mole %.

In any or all embodiments a fiber-based source may include a passively mode locked fiber oscillator based on a Tm, Tm:Ho, or a Ho doped fiber.

In any or all embodiments a highly nonlinear waveguide may include a highly non-linear fiber having a germanosilicate core region with a relative vibrational contribution α to the nonlinear response function, and α>0.18.

In any or all embodiments a highly non-linear waveguide may include a highly nonlinear non-silica fiber having a core region with a relative vibrational contribution α to the nonlinear response function, and α>0.10.

In any or all embodiments a highly nonlinear non-silica fiber may include a material comprising a soft or heavy metal oxide glass.

In any or all embodiments a highly nonlinear non-silica fiber may be selected from SF-6, bismuth, lead, tellurite, fluoride, fluorotellurite or chalcogenide glasses.

In any or all embodiments a highly nonlinear non-silica fiber may be dispersion flattened with a dispersion value <|50|ps²/km in a spectral range within ±100 nm of the central wavelength of the laser source.

In any or all embodiments a highly non-linear waveguide may include a highly nonlinear non-silica fiber having a core region with a ratio of peak Raman gain coefficient to nonlinear refractive index >2.0×10⁶ m⁻¹.

In any or all embodiments a fiber-based source may produce pulses with a pulse width <300 fs.

In any or all embodiments a fiber-based source may produce pulses with a pulse width <100 fs.

In any or all embodiments a non-linear material of the waveguide may include a core region with a relative vibrational contribution α to the nonlinear response function, and α>0.11.

In any or all embodiments a highly nonlinear material may include silicon, silicon nitride, bismuth or tellurite.

In any or all embodiments an output of the supercontinuum source may exhibit high phase coherence at least at two spectral points within the one-half octave; the two spectral points also being separated by at least one-half of an octave.

In any or all embodiments a highly nonlinear waveguide may include high numerical aperture photonic crystal fiber (PCF) having a core and a single layer of air holes at least partially surrounding the core.

At least one embodiment includes a supercontinuum source. The supercontinuum source includes a fiber-based laser source generating short optical pulses. The optical pulses are generated at a repetition rate greater than about 1 GHz, and the short optical pulses comprise a pulse width <1 ps. A highly nonlinear waveguide, which includes a highly non-linear material, is arranged to receive optical pulses from the source and to generate a supercontinuum. The generated supercontinuum is characterized by having a first order coherence function >0.9 obtainable at two spectral locations within said supercontinuum, wherein said spectral locations are separated by at least one octave.

In any or all embodiments spectral locations may be separated by at least 1.1 octaves.

At least one embodiment includes a supercontinuum source. The supercontinuum source includes a fiber-based pulsed laser source generating femtosecond or picosecond pulses with wavelengths greater than about 1700 nm. The supercontinuum source includes a highly non-linear medium that receives pulses from the pulsed laser source. The highly non-linear medium is responsive to the femtosecond or picosecond pulses from the source, and is capable of providing an enhanced non-linear response function at the wavelength. The fiber-based pulsed source and the highly non-linear medium are arranged in such a way that the enhanced non-linear response provides increased coherence over a −30 dB supercontinuum spectral bandwidth of at least about one-half octave and up to about four octaves.

In any or all embodiments a highly non-linear medium is arranged as a portion of a dispersion flattened optical fiber, the dispersion flattened optical fiber further increasing coherence over the spectral bandwidth.

For purposes of summarizing the present invention, certain aspects, advantages and novel features of the present invention are described herein. It is to be understood, however, that not necessarily all such advantages may be achieved in accordance with any particular embodiment. Thus, the present invention may be embodied or carried out in a manner that achieves one or more advantages without necessarily achieving other advantages as may be taught or suggested herein.

Thus, while only certain embodiments have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A supercontinuum source comprising;
a fiber-based laser source generating short optical pulses, said source generating output pulses at a central wavelength >1700 nm, said short optical pulses comprising a pulse width <5 ps; and
a highly non-linear waveguide comprising a highly nonlinear material, said waveguide arranged to receive output pulses from said fiber-based source and to generate a supercontinuum;
wherein said supercontinuum is characterized by having a first order coherence function >0.9 obtainable at two spectral locations within said supercontinuum, wherein said spectral locations are separated by at least one-half octave.

2. The supercontinuum source according to claim 1, wherein said highly non-linear waveguide comprises a highly nonlinear silica fiber comprising a core region with a Germania concentration >10 mole %.

3. The supercontinuum source according to claim 2, wherein said highly nonlinear silica fiber is dispersion flattened with a dispersion value <|50|ps²/km in a spectral range within ±100 nm of the central wavelength of said laser source

4. The supercontinuum source according to claim 1, wherein said continuum covers a spectral bandwidth larger than half an octave measured between two −30 dB points.

5. The supercontinuum source according to claim 1, wherein said highly non-linear waveguide comprises dispersion flattened optical fiber.

6. The supercontinuum source according to claim 1, wherein said highly non-linear waveguide comprises a photonic crystal fiber.

7. The supercontinuum source according to claim 6, wherein said photonic crystal fiber is silica based and comprises a core region with a Germania concentration >10 mole %.

8. The supercontinuum source according to claim 1, wherein said fiber-based source comprises a passively mode locked fiber oscillator based on a Tm, Tm:Ho, or a Ho doped fiber.

9. The supercontinuum source according to claim 1, wherein said highly nonlinear waveguide comprises a highly non-linear fiber comprising a germanosilicate core region with a relative vibrational contribution α to the nonlinear response function, and α>0.18.

10. The supercontinuum source according to claim 1, wherein said highly non-linear waveguide comprises a highly nonlinear non-silica fiber comprising a core region with a relative vibrational contribution α to the nonlinear response function, and α>0.10.

11. The supercontinuum source according to claim 10, wherein said highly nonlinear non-silica fiber comprises a material comprising a soft or heavy metal oxide glass.

12. The supercontinuum source according to claim 10, wherein said highly nonlinear non-silica fiber is selected from SF-6, bismuth, lead, tellurite, fluoride, fluorotellurite or chalcogenide glasses.

13. The supercontinuum source according to claim 10, wherein said highly nonlinear non-silica fiber is dispersion flattened with a dispersion value <|50|ps²/km in a spectral range within ±100 nm of the central wavelength of said laser source

14. The supercontinuum source according to claim 1, wherein said highly non-linear waveguide comprises a highly nonlinear non-silica fiber comprising a core region having a ratio of peak Raman gain coefficient to nonlinear refractive index >2.0×10⁶ m⁻¹.

15. The supercontinuum source according to claim 1, wherein said fiber-based source produces pulses with a pulse width <300 fs.

16. The supercontinuum source according to claim 1, wherein said fiber-based source produces pulses with a pulse width <100 fs.

17. The supercontinuum source according to claim 1, wherein said non-linear material of said waveguide comprises a core region with a relative vibrational contribution α to the nonlinear response function, and α>0.11.

18. The supercontinuum source according to claim 1, wherein said highly nonlinear material comprises silicon, silicon nitride, bismuth or tellurite.

19. The supercontinuum source according to claim 1, said supercontinuum source exhibiting high phase coherence at least at two spectral points within said one-half octave; said two spectral points also being separated by at least one-half of an octave.

20. The supercontinuum source according to claim 1, wherein said highly nonlinear waveguide comprises a high numerical aperture photonic crystal fiber (PCF) having a core and a single layer of air holes at least partially surrounding said core.

21. A supercontinuum source, comprising;
a fiber-based laser source generating short optical pulses at a repetition rate greater than about 1 GHz, wherein said short optical pulses comprise a pulse width <1 ps; and
a highly nonlinear waveguide comprising a highly non-linear material and arranged to receive optical pulses from said source and to generate a supercontinuum;
wherein said supercontinuum is characterized by having a first order coherence function >0.9 obtainable at two spectral locations within said supercontinuum, wherein said spectral locations are separated by at least one octave.

22. The supercontinuum source according to claim 21, wherein said spectral locations are separated by at least one 1.1 octaves.

23. A supercontinuum source, comprising:
a fiber-based pulsed laser source generating femtosecond or picosecond pulses with wavelengths greater than about 1700 nm;
a highly non-linear medium receiving pulses from said pulsed laser source, said highly non-linear medium responsive to said femtosecond or picosecond pulses from said source and capable of providing an enhanced non-linear response function at said wavelength,
wherein said fiber-based pulsed source and said highly non-linear medium are arranged in such a way that said enhanced non-linear response provides increased coherence over a −30 dB supercontinuum spectral bandwidth of at least about one-half octave and up to about four octaves.

24. The supercontinuum source according to claim 23, wherein said highly non-linear medium is arranged as a portion of a dispersion flattened optical fiber, said dispersion flattened optical fiber further increasing coherence over said spectral bandwidth.
